(19) United States
(12) Patent Application Publication
(10) Pub. No.: US 2025/0006161 A1
(43) Pub. Date: Jan. 2, 2025

(54) ELECTRONIC MUSICAL INSTRUMENT AND METHOD FOR TEMPERATURE COMPENSATION OF POSITION DETECTION CIRCUIT

(71) Applicant: Roland Corporation, Shizuoka (JP)

(72) Inventors: Hajime Hisamitsu, Shizuoka (JP); Toshihiko Sakashita, Shizuoka (JP)

(73) Assignee: Roland Corporation, Shizuoka (JP)

(21) Appl. No.: 18/747,378

(22) Filed: Jun. 18, 2024

(30) Foreign Application Priority Data
Jun. 30, 2023 (JP) 2023-108252

(51) Int. Cl. G10H 1/34

(52) U.S. Cl. CPC G10H 1/344; G10H 2220/221; G10H 2220/275

(57) ABSTRACT

An electronic musical instrument and a method for temperature compensation of a position detection circuit. The electronic musical instrument includes: an operator of which position is changed by being operated; a magnetic sensor outputting an AC voltage in response to a change in the position of the operator; a rectifier diode receiving the AC voltage at an anode and outputting a voltage rectified from a cathode; a calculation circuit calculating a compensation voltage from a forward voltage generated in a diode to which a predetermined voltage is applied in a forward direction; and a compensation circuit applying the compensation voltage to an anode side or a cathode side of the rectifier diode in a state where the AC voltage is being input. The position of the operator is detected according to the voltage from the rectifier diode to which the compensation voltage is applied by the compensation circuit.

### CROSS-REFERENCE TO RELATED APPLICATION

This application claims the priority benefits of Japanese application no. 2023-108252, filed on Jun. 30, 2023. The entirety of the above-mentioned patent application is hereby incorporated by reference herein and made a part of this specification.

### BACKGROUND

### Technical Field

The disclosure relates to an electronic musical instrument and a method for temperature compensation of a position detection circuit.

### Description of Related Art

Patent Literature 1 (Japanese Utility Model Application Laid-Open No. 02-111199) describes a position detection circuit that detects the position of an operator using a magnetic sensor that displaces a magnet 8 (detected unit) fixed to a key 2 (operator) relative to a coil in a keyboard device for an electronic musical instrument. According to the position detection circuit, since a direct current (DC) voltage is generated in the coil according to the distance of the detected unit to the coil, the position of the operator can be detected by a detection unit such as a CPU in response to the DC voltage.

A magnetic sensor of other types outputs an alternating current (AC) voltage from the coil according to the position of the operator (detected unit). In this case, in order to convert the output from the magnetic sensor into a signal suitable for input to the detection unit, the position detection circuit converts the AC voltage from the magnetic sensor into a DC voltage using a rectifier diode or the like, and then further converts the DC voltage before outputting the DC voltage to the detection unit. On the output (cathode) side of the rectifier diode, a voltage drop occurs by the forward voltage of the rectifier diode compared to the input (anode) side.

### SUMMARY

However, in the above technique, the forward voltage of the rectifier diode varies depending on the temperature of the rectifier diode, and therefore the signal input to the detection unit also varies depending on the temperature. Therefore, it becomes difficult to detect the accurate position of the operator from the signal.

The disclosure provides an electronic musical instrument and a method for temperature compensation of a position detection circuit that can improve the detection accuracy of the position of an operator.

The electronic musical instrument of the disclosure includes: an operator of which position is changed by being operated by a performer; a magnetic sensor which outputs an AC voltage in response to a change in the position of the operator; a rectifier diode which receives the AC voltage from the magnetic sensor at an anode and outputs a rectified voltage from a cathode; a calculation means for calculating a compensation voltage from a forward voltage generated in a diode to which a predetermined voltage is applied in a forward direction; and a compensation means for applying the compensation voltage calculated by the calculation means to an anode side or a cathode side of the rectifier diode in a state where the AC voltage from the magnetic sensor is being input. The position of the operator is detected according to the voltage from the rectifier diode to which the compensation voltage is applied by the compensation means.

The method for temperature compensation of the position detection circuit of the disclosure is a method for an electronic musical instrument which includes an operator of which position is changed by being operated by a performer, a magnetic sensor which outputs an AC voltage in response to a change in the position of the operator, and a rectifier diode which receives the AC voltage from the magnetic sensor at an anode and outputs a rectified voltage from a cathode. The method for temperature compensation includes a calculation step of calculating a compensation voltage from a forward voltage generated in a diode to which a predetermined voltage is applied in a forward direction, and a compensation step of applying the compensation voltage calculated in the calculation step to an anode side or a cathode side of the rectifier diode. The position of the operator is detected according to the voltage from the rectifier diode to which the compensation voltage is applied in the compensation step.

### BRIEF DESCRIPTION OF THE DRAWINGS

FIG. 1 is a cross-sectional view of an electronic musical instrument according to a first embodiment.

FIG. 2 is a block diagram showing the electrical configuration of the electronic musical instrument.

FIG. 3 is a diagram schematically showing a position detection circuit.

FIG. 4 is a diagram showing voltage states of various units when no temperature compensation is performed.

FIG. 5 is a diagram showing voltage states of various units when temperature compensation is performed.

FIG. 6 is a diagram schematically showing a position detection circuit of an electronic musical instrument according to a second embodiment.

FIG. 7 is a diagram showing voltage states of various units in the second embodiment when temperature compensation is performed.

### DESCRIPTION OF THE EMBODIMENTS

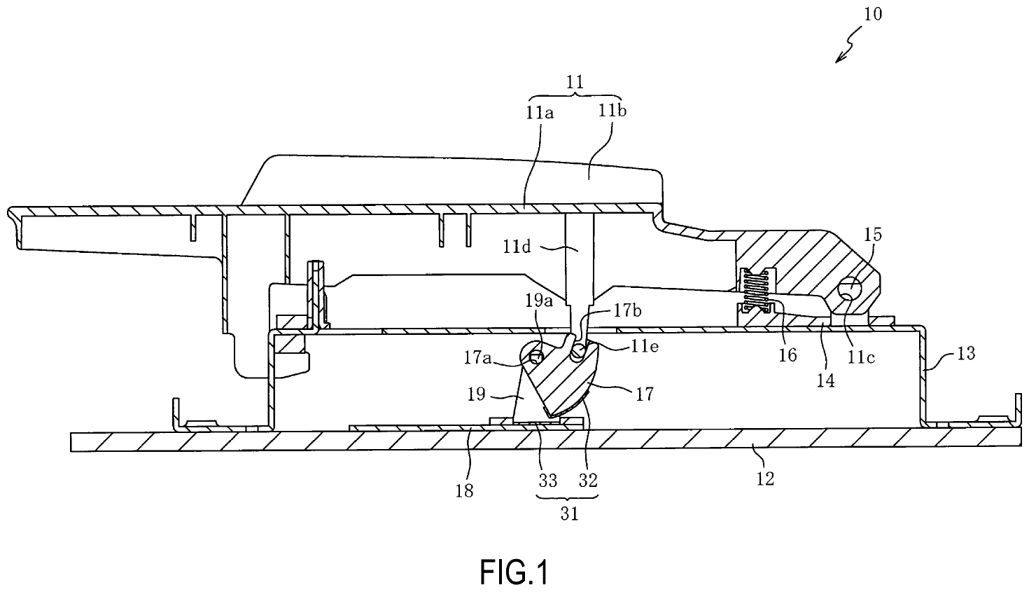

Hereinafter, exemplary embodiments are described with reference to the accompanying drawings. First, an electronic musical instrument 10 according to a first embodiment will be described with reference to FIG. 1. FIG. 1 is a cross-sectional view of the electronic musical instrument 10. In the following description, the side closest to a performer (the left side in FIG. 1) is the front side of the electronic musical instrument 10, and the opposite side (the right side in FIG. 1) is the rear side.

The electronic musical instrument 10 is a keyboard instrument (synthesizer) that includes multiple keys 11 (operators) that extend in a front-rear direction. The keys 11 are composed of multiple (52 in the embodiment) white keys 11a for playing fundamental notes and multiple (36 in the embodiment) black keys 11b for playing derived notes. The white keys 11a and the black keys 11b are arranged in a scale direction (the direction perpendicular to the plane of the paper in FIG. 1). FIG. 1 shows a cross section of the electronic musical instrument 10 taken along a plane perpendicular to the scale direction. In addition, in the embodiment, a total of 88 keys 11 are provided, but a configuration in which, for example, 76 or 61 keys 11 are provided may also be used.

The electronic musical instrument 10 has a chassis 13 fixed to the upper surface of a bottom plate 12 of a flat plate shape, and the keys 11 are attached to the chassis 13 via support members 14. The bottom plate 12 and the chassis 13 are each formed of synthetic resin, wood, steel plate, or the like, and extend in the scale direction. The chassis 13 is formed in a box shape with an opening at a bottom surface, and the bottom surface is closed by the bottom plate 12.

The support member 14 is for rotatably supporting the key 11 and is fixed to the rear end side of the upper surface of the chassis 13. The structure for supporting the white key 11a by the support member 14 and the method for detecting the position of the white key 11a will be described below, but the structure and method are substantially the same for the black key 11b.

The support member 14 rotatably supports the white key 11a by inserting a rotation shaft 15 along the scale direction into a through hole 11c provided at the rear end unit of the white key 11a. In front of the rotation shaft 15, a coil spring 16 is sandwiched between the white key 11a and the support member 14 from above and below.

When a performer presses the white key 11a, the coil spring 16 is elastically deformed. When the white key 11a is released from the state, the elastic restoring force of the coil spring 16 causes the white key 11a to return to its initial position. When the white key 11a is pressed and released (operated), the displacement member 17 rotates around the rotation shaft 15 of the white key 11a, and the displacement of the displacement member 17 is detected by a magnetic sensor 31 of a position detection circuit 30. The position detection circuit 30 is mainly formed on a substrate 18 of a flat plate shape placed on the upper surface of the bottom plate 12, and will be described in detail later.

The displacement member 17 is supported by a holder 19 in a space surrounded by the bottom plate 12 and the chassis 13. The holder 19 stands up from the substrate 18 and has a shaft unit 19a at the upper end unit thereof. The displacement member 17 is rotatably supported by the holder 19 by inserting the shaft unit 19a along the scale direction into an insertion hole 17aprovided on the upper side of the displacement member 17.

A protrusion 11d protrudes downward from the underside of the white key 11a, and a pin 11e protrudes in the scale direction from the lower end of the protrusion 11d. The pin 11e is slidably fitted into a groove 17b provided in the displacement member 17. As a result, when the white key 11a is pressed, the displacement member 17 rotates toward the front around the shaft unit 19a. On the other hand, when the white key 11a is released, the displacement member 17 rotates toward the rear around the shaft unit 19a.

The magnetic sensor 31 includes a detected unit 32 provided on the lower portion of the displacement member 17 and a coil 33 provided on the upper surface of the substrate 18. When the displacement member 17 rotates in response to the operation of the white key 11a, the detected unit 32 is displaced relative to the coil 33.

More specifically, as the white key 11a is pressed downward more, the intrusion amount of the detected unit 32 into the area facing the coil 33 (hereinafter referred to as the “detection area”) increases. The intrusion amount of the detected unit 32 is the size of the area where the detected unit 32 and the coil 33 face each other in the thickness direction of the substrate 18. The intrusion amount of the detected unit 32 is minimum when the white key 11a is in the initial position where the white key 11a is not pressed, and is maximum when the white key 11a is pressed all the way down.

The detected unit 32 is a conductor made of a conductive material (such as copper). Therefore, when an AC voltage is applied to the coil 33 to generate a magnetic field, if the intrusion amount of the detected unit 32 into the detection area increases, the inductance of the coil 33 decreases. On the other hand, when the intrusion amount decreases, the inductance of the coil 33 increases. The peak value of the AC voltage output from the coil 33 varies depending on whether the inductance is increased or decreased.

That is, the peak value of the AC voltage output from the coil 33 of the magnetic sensor 31 varies depending on the position of the white key 11a. Therefore, the electronic musical instrument 10 can detect the position of the white key 11a by appropriately obtaining the variation in the peak value of the AC voltage using the position detection circuit 30. By accurately detecting the position of the white key 11a, the electronic musical instrument 10 can determine the position of the jack of the piano action, define the aftertouch area, and so on.

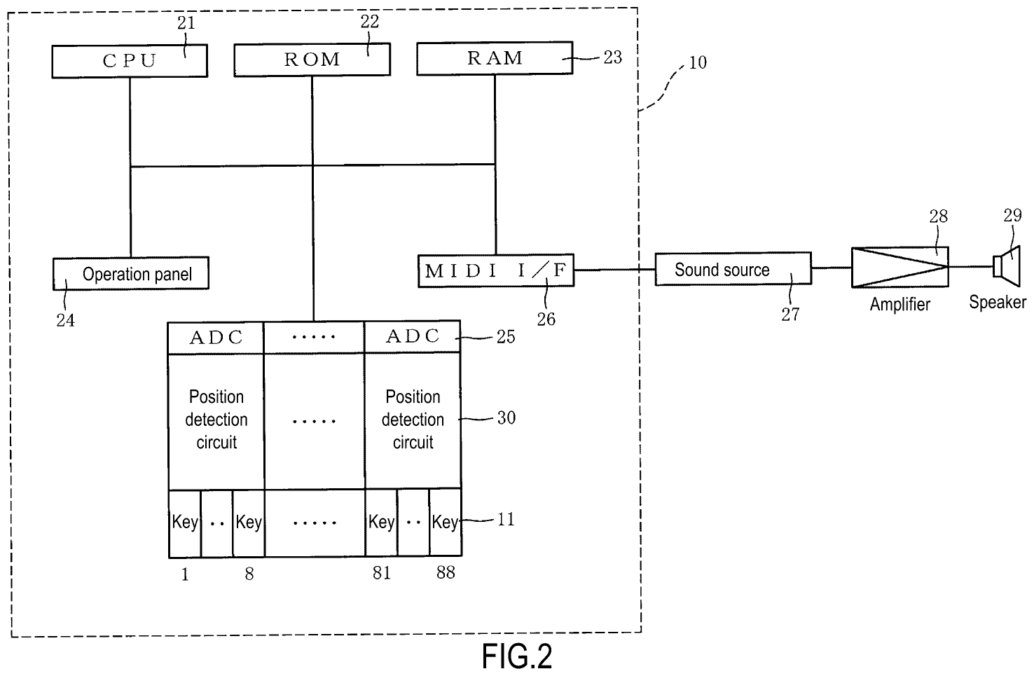

Next, the electrical circuitry of the electronic musical instrument 10, including the position detection circuit 30, will be described with reference to FIG. 2. FIG. 2 is a block diagram showing the electrical configuration of the electronic musical instrument 10 and devices connected to the electronic musical instrument 10.

The electronic musical instrument 10 includes a central processing unit (CPU) 21, a read only memory (ROM) 22, a random access memory (RAM) 23, an operation panel 24, an analog-to-digital converter (ADC) 25, and a MIDI interface (I/F) 26. The units 21 to 26 are electrically connected to each other.

The ROM 22 is a memory in which a control program and the like executed by the CPU 21 are stored. The RAM 23 is a memory for rewritably storing various work data, flags, etc. when the CPU 21 executes the control program. The operation panel 24 is provided with multiple operators for tuning the performance information generated by the electronic musical instrument 10.

One position detection circuit 30 and one ADC 25 are provided for every eight keys 11. The position detection circuit 30 acquires output from the magnetic sensor 31 provided for each of the keys 11 in a time-division manner, and outputs the output to the ADC 25. The ADC 25 is a converter that samples the analog signal of the voltage output from the position detection circuit 30 at predetermined intervals and converts the analog signal into a digital signal that can be read by the CPU 21. The ADC 25 may be built into the CPU 21.

The MIDI interface 26 is an interface that outputs performance information conforming to the MIDI standard in response to the operation of the keys 11 (the detection results of the position detection circuit 30). A sound source 27 connected to the MIDI interface 26 outputs a musical tone signal in accordance with the input performance information. The output musical tone signal is amplified by an amplifier 28 and emitted by a speaker 29. The sound source 27 to the speaker 29 are not limited to being provided externally to the electronic musical instrument 10, but may be built into the electronic musical instrument 10.

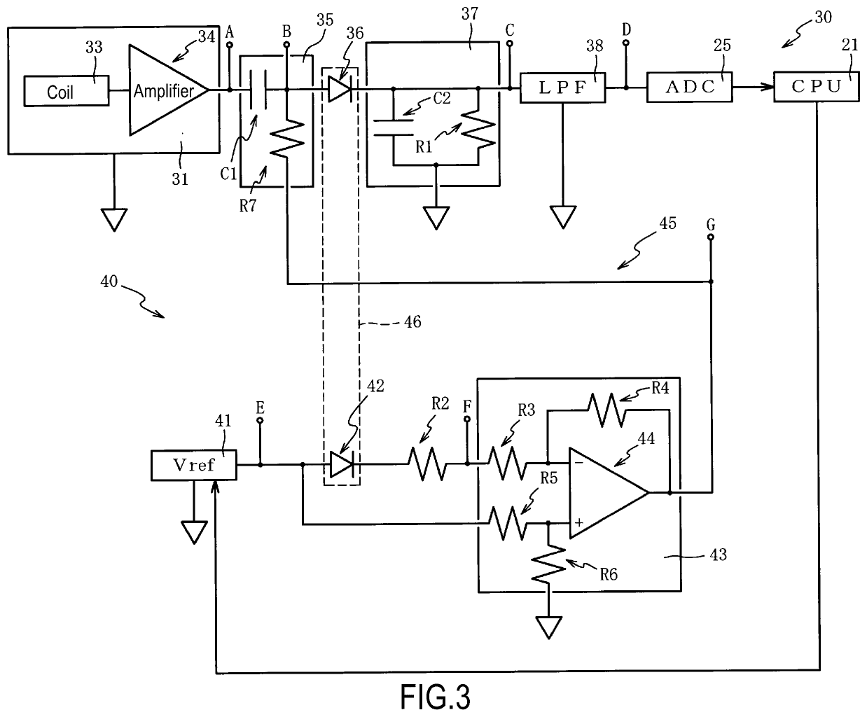

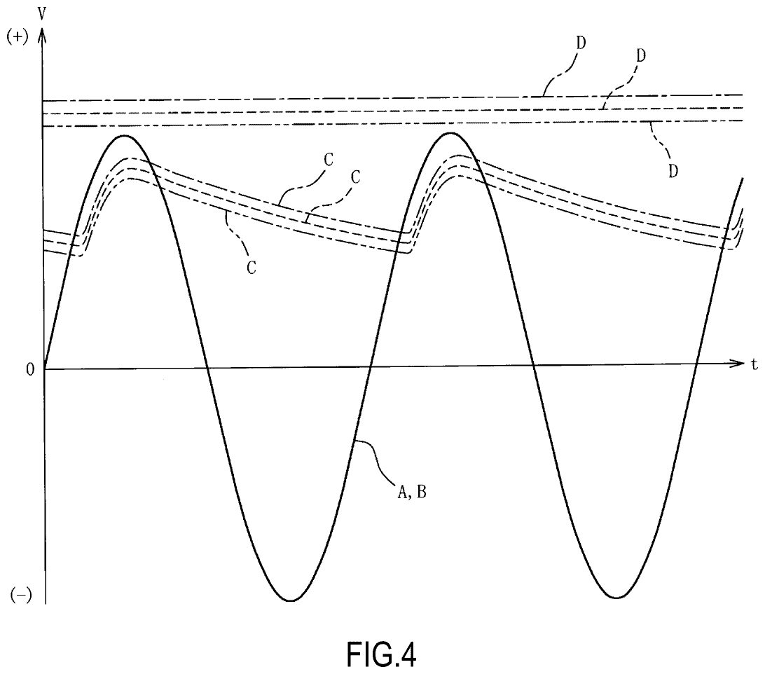

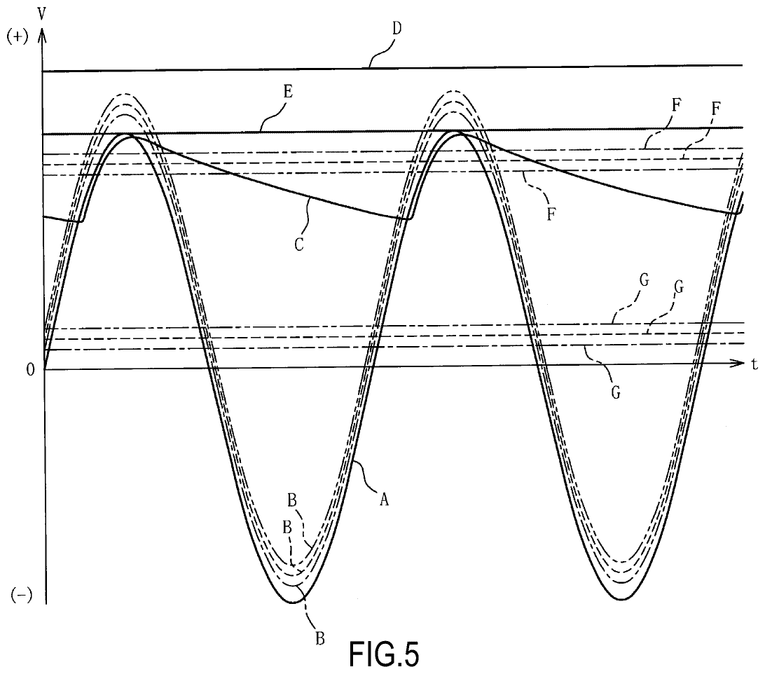

Next, the detailed configuration of the position detection circuit 30 will be described with reference to FIGS. 3 to 5. FIG. 3 is a diagram schematically showing the position detection circuit 30. FIG. 4 is a diagram showing the voltage states of the various units of the position detection circuit 30 when no temperature compensation is performed. FIG. 5 is a diagram showing the voltage states of the various units of the position detection circuit 30 when temperature compensation is performed. In FIGS. 4 and 5, the vertical axis represents voltage, and the horizontal axis represents time. Graphs A to F in FIGS. 4 and 5 are graphs of voltages at positions A to F shown in FIG. 3.

As shown in FIG. 3, the position detection circuit 30 is a circuit that converts an AC voltage output from the coil 33 of the magnetic sensor 31 into a voltage suitable for input to the ADC 25. This suitable voltage is a DC voltage corresponding to the peak value of the AC voltage from the coil 33. This is because the voltage sampled by the ADC 25 corresponds to the peak value, and the position of the key 11 is detected by the CPU 21 based on the digital signal of the peak value.

The position detection circuit 30 mainly includes the magnetic sensor 31, an AC coupling 35, a rectifier diode 36, a smoothing circuit 37, a low pass filter (LPF) 38, and a temperature compensation circuit 40. First, with reference to FIGS. 3 and 4, a case where there is no temperature compensation circuit 40 (a circuit connected from below at position B in FIG. 3) will be described.

The magnetic sensor 31 includes an amplifier 34 built therein for amplifying and outputting the AC voltage output from the coil 33. The coil 33 and the amplifier 34 are connected to the same ground (reference potential 0V). The amplifier 34 is not limited to being built into the magnetic sensor 31, and may be provided externally to the magnetic sensor 31.

The output side of the magnetic sensor 31 (amplifier 34) is connected to the rectifier diode 36 via a capacitor C1 of the AC coupling 35. Although not shown, a switch is provided between the eight magnetic sensors 31 and the capacitor C1 to select one of the output from the eight magnetic sensors 31 and input the selected output to the capacitor C1. When the amplifier 34 is provided externally to the magnetic sensor 31, the above-mentioned switch may be provided between the eight coils 33 and the amplifier 34. In this case, the number of amplifiers 34 can be reduced relative to the number of keys 11, and the cost and size of the position detection circuit 30 can be reduced.

The capacitor C1 passes the AC current from the magnetic sensor 31 as is. Therefore, the voltage at a position A between the magnetic sensor 31 and the capacitor C1 and the voltage at a position B between the capacitor C1 and the rectifier diode 36 become the same.

The rectifier diode 36 is a pn junction type semiconductor that allows current to flow easily in the forward direction from the anode to the cathode, but does not allow current to flow in the reverse direction. In the following description, the voltage in the forward direction is defined as positive (+) and the voltage in the reverse direction is defined as negative (−).

The anode of the rectifier diode 36 is connected to the output side of the magnetic sensor 31 via the capacitor C1. As a result, the rectifier diode 36 half-wave rectifies the AC voltage input from the magnetic sensor 31 to the anode, converts the rectified voltage into a pulsating voltage, and outputs the voltage from the cathode.

The smoothing circuit 37 is a circuit that smoothes the pulsating voltage output from the cathode of the rectifier diode 36, and is connected between the cathode and the LPF 38. The smoothing circuit 37 includes a capacitor C2 and a resistor R1. The capacitor C2 and the resistor R1 are provided in parallel between the ground and the respective parts branched off from the electric wire connecting the rectifier diode 36 and the LPF 38. In the smoothing circuit 37, the capacitor C2 is charged up to the peak of the input pulsating current, and when the peak is exceeded, the capacitor C2 is gradually discharged to the resistor R1, so the smoothed pulsating current can be output.

The rectifier diode 36 and the smoothing circuit 37 form a known envelope detection circuit. As shown in FIG. 4, the voltage at position C output from the envelope detection circuit (smoothing circuit 37) becomes the envelope of the voltage at position B in the vicinity of the positive peak. The peak value of the envelope is slightly lower than the peak of the voltage at position B.

This is because the rectifier diode 36 causes a voltage drop in the forward voltage. The forward voltage is the voltage generated across the rectifier diode 36 when a forward current flows through the rectifier diode 36. When the potential difference between the anode and cathode of the rectifier diode 36 is equal to or less than the forward voltage, no current flows through the rectifier diode 36. On the other hand, if the potential difference is larger than the forward voltage, a voltage drop of the forward voltage occurs on the cathode side relative to the anode side.

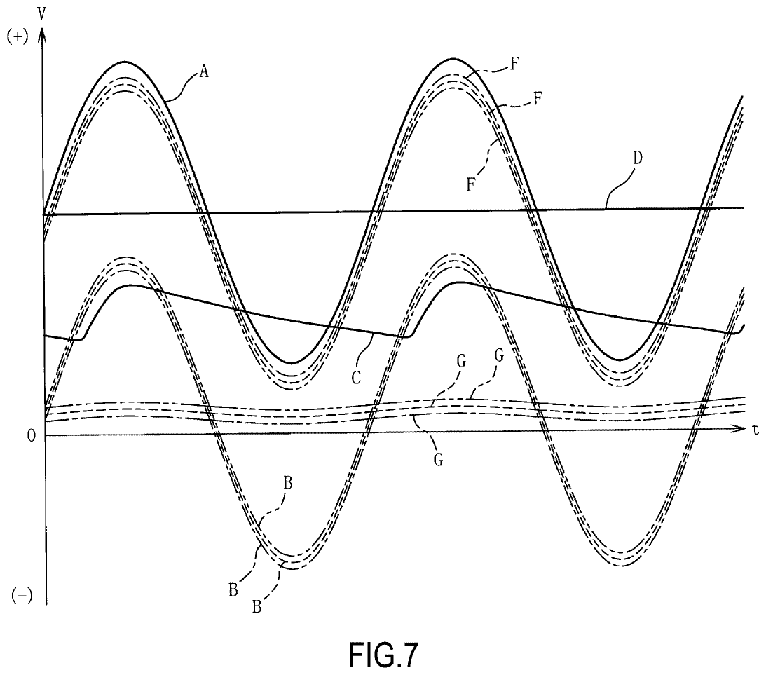

Furthermore, the higher the temperature of the rectifier diode 36, the smaller the forward voltage of the rectifier diode 36 becomes, and the larger the voltage at position C becomes. Therefore, in FIG. 4, the voltage at position C is shown by a dashed line when the temperature is about 25° C., a higher temperature than the dashed line is shown by a one-dot chain line, and a lower temperature than the dashed line is shown by a two-dot chain line. The relationship is the same for the voltage at position D in FIG. 4 and the voltages at positions B, F, and G in FIGS. 5 and 7.

Among the frequencies of the voltage input from the smoothing circuit 37, the LPF 38 passes frequencies below the cutoff frequency, while cutting off (reducing) frequencies above the cutoff frequency and outputs the frequencies to the ADC 25. The cutoff frequency is set to a value lower than the frequency of the coil 33 so that the frequency component of the voltage output from the coil 33 is cut off.

As a result, the voltage at position D output from the LPF 38 becomes a DC voltage based on the peak value of the voltage at position C. More specifically, the voltage at position D is a value obtained by amplifying the peak value of the voltage at position C by a predetermined amplification factor. The amplification factor of the LPF 38 may be changed as appropriate, or may be 1.

The DC voltage at position D is sampled by the ADC 25, and the CPU 21 detects the position of the key 11 based on the sampling result (the value of the DC voltage). However, if temperature compensation is not performed, the DC voltage at position D varies depending on the temperature of the rectifier diode 36, so the temperature causes the detection result of the position of the key 11 by the CPU 21 to vary.

The temperature compensation circuit 40 is a circuit for compensating for the variation due to temperature. Hereinafter, the temperature compensation circuit 40 (when performing temperature compensation) will be described with reference to FIGS. 3 and 5. The temperature compensation circuit 40 includes a reference voltage circuit 41, a temperature compensation diode 42, a resistor R2, and a subtraction circuit 43.

The reference voltage circuit 41 is a circuit that continues to output a constant DC voltage Vref with respect to a reference potential, regardless of the power supply voltage, temperature, and the like. The DC voltage Vref in the embodiment is the voltage at position E, and is set to be equal to the peak value of the positive voltage at position A when the key 11 is in the initial position. The reference voltage circuit 41 outputs the DC voltage Vref based on a command from the CPU 21.

The temperature compensation diode 42 is provided separately from the rectifier diode 36 and is configured to have the same characteristics as the rectifier diode 36. The anode of the temperature compensation diode 42 is connected to the output side of the reference voltage circuit 41, and the cathode of the temperature compensation diode 42 is connected to the resistor R2. The resistor R2 is provided to regulate the value of the current flowing through the temperature compensation diode 42.

Similar to the rectifier diode 36, the temperature compensation diode 42 also generates a forward voltage that varies depending on the temperature of the temperature compensation diode 42. Therefore, the voltage at position F on the output side of resistor R2 drops from the voltage at position E by the forward voltage of temperature compensation diode 42 and the voltage applied to the resistor R2. The voltage of the resistor R2 is sufficiently small compared to the forward voltage of temperature compensation diode 42 and can therefore be ignored. In other words, the difference obtained by subtracting the voltage at position F from the voltage at position E can be said to be the forward voltage of the temperature compensation diode 42.

The subtraction circuit 43 (calculation means) is a circuit for calculating the forward

voltage of the temperature compensation diode 42. The subtraction circuit 43 includes an operational amplifier 44 and resistors R3 to R6. The inverting input terminal (−) of the operational amplifier 44 is connected to the output side (position F) of the resistor R2 via the resistor R3. A branch from between the inverting input terminal of the operational amplifier 44 and the resistor R3 is connected to the output terminal of the operational amplifier 44 (the right end of the operational amplifier 44 in FIG. 3) via the resistor R4.

A branch from between the reference voltage circuit 41 and the temperature compensation diode 42 (position E) is connected to the non-inverting input terminal (+) of the operational amplifier 44 via the resistor R5. A branch from between the resistor R5 and the non-inverting input terminal of the operational amplifier 44 is connected to the ground via the resistor R6.

Since resistance values of the resistors R3 to R6 are substantially the same, the subtraction circuit 43 outputs the forward voltage (the voltage at position G) of the temperature compensation diode 42 obtained by subtracting the voltage at position F from the voltage at position E from the output terminal (calculation step). The forward voltage is a compensation voltage for temperature compensating the rectifier diode 36.

The output terminal of the subtraction circuit 43 is connected via a joining line 45 between the capacitor C1 and the anode of the rectifier diode 36 (position B). A resistor R7 is provided midway along the joining line 45, between position G and position B. The resistor R7 and capacitor C1 form the AC coupling 35 (high-pass filter).

In the AC coupling 35 (compensation means), the capacitance of the capacitor C1 and the resistance value of the resistor R7 are set so as to pass the AC voltage from the magnetic sensor 31 while cutting off the DC compensation voltage from the subtraction circuit 43. As a result, the voltage at position B becomes the AC voltage (voltage at position A) from the magnetic sensor 31 plus the compensation voltage (voltage at position G) (compensation step). In other words, the voltage at position B is a voltage of which center of amplitude is shifted toward the positive side by the compensation voltage with respect to the voltage at position A.

The hotter the temperature compensation diode 42 is, the smaller the compensation voltage at position G becomes, and similarly the smaller the voltage shift at position B becomes. When the voltage at position B drops due to the forward voltage of the rectifier diode 36, the higher the temperature of the rectifier diode 36, the smaller the amount of voltage drop becomes.

That is, the forward voltage of the rectifier diode 36, which is subtracted (voltage drop) from the AC voltage from the magnetic sensor 31, and the compensation voltage of the temperature compensation diode 42, which is added to the AC voltage from the magnetic sensor 31, similarly vary depending on the temperature. As a result, the temperature dependency of the voltage drop caused by the rectifier diode 36 can be canceled out by the temperature dependency of the compensation voltage added to the anode side of the rectifier diode 36.

As a result, variations in the voltages at positions C and D when temperature compensated due to the temperature of the rectifier diode 36 are suppressed. In this way, the temperature dependency of the detection result of the position detection circuit 30 inputted to the CPU 21 via the ADC 25 can be reduced. Therefore, according to the electronic musical instrument 10, the detection accuracy of the position of the key 11 based on the detection result can be improved.

The compensation voltage for canceling the temperature dependency of the rectifier diode 36 is not calculated by the CPU 21 or the like, but is calculated by hardware called the temperature compensation circuit 40, as described above. In this way, the load on the CPU 21 for calculating the compensation voltage can be reduced.

Furthermore, if the compensation voltage is DC, then the temperature compensation circuit 40 can be connected to the anode of the rectifier diode 36 by the AC coupling 35. Since the CPU 21 is not involved in the input of the compensation voltage to the anode of the rectifier diode 36, the load on the CPU 21 can be reduced.

Moreover, as a circuit for adding a compensation voltage to the AC voltage from the magnetic sensor 31, in addition to the AC coupling 35, for example, an adder circuit including an operational amplifier may be used. However, using the AC coupling 35 can simplify the circuit configuration, and the position detection circuit 30 can be made smaller and less expensive.

Each of the position detection circuits 30 is provided with the rectifier diode 36 and the temperature compensation diode 42 in a one-to-one relationship. In this way, the rectifier diode 36 and the temperature compensation diode 42 for compensating for the voltage drop caused by the rectifier diode 36 can be disposed close to each other, and the temperatures of the respective diodes 36 and 42 can be easily brought close to each other. As a result, the temperature dependency of the detection result of the position detection circuit 30 can be made smaller, and the detection accuracy of the position of the key 11 can be improved.

Furthermore, the rectifier diode 36 and the temperature compensation diode 42 provided in a one-to-one relationship are sealed in the same sealing material 46 and assembled into one chip. The diodes 36 and 42 in one chip are thermally coupled to each other and have substantially the same temperature, and can be said to be composed of diodes of which forward voltages have substantially the same temperature dependency. As a result, the forward voltages of the diodes 36 and 42 can be made substantially the same regardless of the temperature, and the temperature dependency of the detection result of the position detection circuit 30 can be further reduced. As a result, the detection accuracy of the position of the key 11 can be further improved.

The forward voltage of each of the diodes 36 and 42 also depends on the value (hereinafter referred to as the “current value”) of the forward current flowing through each of the diodes 36 and 42. The current value varies depending on the voltage input to each of the diodes 36 and 42.

When the key 11 is in the initial position, the peak value of the AC voltage at position B input to the rectifier diode 36 is substantially equal to the DC voltage Vref input to the temperature compensation diode 42, and the difference therebetween is small. In this way, the forward voltages of the diodes 36 and 42 can be made substantially the same in the vicinity of the peak value, and the voltage drop in the forward voltage of the rectifier diode 36 itself can be easily canceled out by the forward voltage (compensation voltage) of the temperature compensation diode 42. Therefore, when the key 11 is in the initial position, the CPU 21 can easily detect (calculate) the position of the key 11 from the detection result of the position detection circuit 30.

In addition, when the key 11 is operated from the initial position, the peak value of the AC voltage at position B varies with respect to the DC voltage Vref of constant magnitude, and a slight difference occurs in the forward voltage of each of the diodes 36 and 42 compared to the initial position. Although the difference also depends on temperature, the difference itself is small and therefore has little effect on the detection accuracy of the position of the key 11. On the other hand, compared to a case where the magnitude of the DC voltage Vref is changed in response to the operation of the key 11, inputting the DC voltage Vref of constant magnitude makes it easier to control the position detection circuit 30 and reduce costs.

Furthermore, even if the diodes 36 and 42 are thermally coupled, it is preferable to make the amounts of heat generated by the diodes 36 and 42 substantially equal to each other so as to reduce the temperature difference between the diodes 36 and 42. The amount of heat generated (temperature) depends mainly on the current value of each of the diodes 36 and 42.

The current value of the temperature compensation diode 42 is determined mainly by the magnitude of the DC voltage Vref input to the temperature compensation diode 42 and the resistance values of the resistors R2 to R6. It is preferable to regulate the resistance values of the resistors R2 to R6 so that the current value becomes the same as the current value of the rectifier diode 36 to which the peak value of the AC voltage at position B when the key 11 is in the initial position is input. In this way, the amount of heat generated (temperature) of each of the diodes 36 and 42 can be made closer to each other, and the detection accuracy of the position of the key 11 can be further improved.

In the embodiment, the resistor R2, which is one of the resistors for regulating the current value (heat generation amount) of the temperature compensation diode 42, is provided externally to the subtraction circuit 43. In this way, the resistance value of the resistor R2 can be easily regulated (changed), and the current value of the temperature compensation diode 42 can be easily regulated.

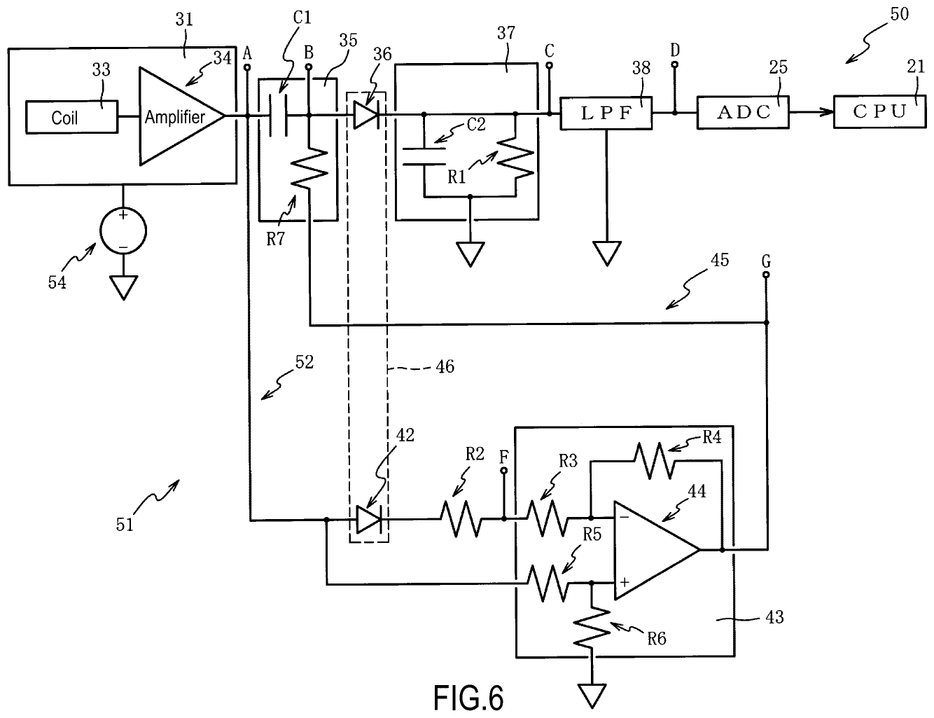

Next, a second embodiment will be described with reference to FIGS. 6 and 7. In addition, the same parts as those in the first embodiment described above are denoted by the same reference numerals and the description thereof will be omitted. FIG. 6 is a diagram schematically showing a position detection circuit 50 of an electronic musical instrument according to the second embodiment. FIG. 7 is a diagram showing the voltage states of the various units of the position detection circuit 50 when temperature compensation is performed.

The electronic musical instrument of the second embodiment has the same configuration as the electronic musical instrument of the first embodiment, except for a temperature compensation circuit 51 of the position detection circuit 50. The temperature compensation circuit 51 is different from the temperature compensation circuit 40 of the first embodiment in that a branch wire 52 and an offset power supply 54 are provided instead of the reference voltage circuit 41.

The branch wire 52 is a wire that branches off from between (position A) the magnetic sensor 31 and the capacitor C1 and is connected to the anode of the temperature compensation diode 42. As a result, the voltage at position A is input to the temperature compensation diode 42. Therefore, the compensation voltage at position G is, by the subtraction circuit 43, basically the forward voltage of the temperature compensation diode 42 when the voltage at position A is input.

The offset power supply 54 is a DC power supply provided to approximate the compensation voltage to DC. The offset power supply 54 is provided between the magnetic sensor 31 and the ground of the magnetic sensor 31. The offset power supply 54 adds a DC offset voltage to the AC voltage output from the magnetic sensor 31.

Since the offset voltage is a direct current, the offset voltage is removed when passing through the capacitor C1 of the AC coupling 35. As a result, the voltage at position B becomes the AC voltage output from the magnetic sensor 31 plus the compensation voltage, and the offset voltage is removed. Therefore, the offset voltage can be suppressed from significantly affecting the detection result of the position detection circuit 50.

The offset voltage is a positive voltage that makes the entire voltage at position A equal to or greater than the forward voltage of the temperature compensation diode 42. For example, specifically, if the minimum value of the voltage at position A is approximately −1.5V and the forward voltage of the temperature compensation diode 42 at 25° C. is approximately 0.3V, the offset voltage is set to 2.2V in consideration of a variation and an error in the forward voltage.

Here, when no offset voltage is added to the AC voltage from the magnetic sensor 31, the compensation voltage, which is the difference between the voltage at position A and the voltage at position F, remains substantially constant mainly when the voltage at position A is positive, and largely varies toward the negative side mainly when the voltage at position A is negative. That is, the compensation voltage becomes a pulsating current having a sufficiently large amplitude relative to the AC voltage from the magnetic sensor 31, and is significantly deviated from the forward voltage of the temperature compensation diode 42. With such a compensation voltage, the rectifier diode 36 may be unable to be appropriately temperature compensated.

In contrast, when an offset voltage is added to the AC voltage from the magnetic sensor 31, a part of the voltage at position A can be prevented from being rectified by the temperature compensation diode 42. As a result, the entire voltage at position F varies along with the voltage at position A, and the compensation voltage at position G approximates DC and represents the forward voltage of the temperature compensation diode 42.

It should be noted that the compensation voltage varies slightly in accordance with a variation in the voltage (AC voltage from the magnetic sensor 31) at position A input to the temperature compensation diode 42. However, the amplitude of the compensation voltage is sufficiently small ( 1/20 or more and 1/10 or less) compared with the amplitude of the AC voltage from the magnetic sensor 31, and the compensation voltage can be considered as DC. In this way, a compensation voltage can be added to the AC voltage from the magnetic sensor 31 by the AC coupling 35.

As described above, according to the position detection circuit 50 of the second embodiment, by providing the branch wire 52 and the offset power supply 54, a voltage can be applied to the temperature compensation diode 42 without passing through the CPU 21, in contrast to the first embodiment. That is, the temperature compensation of the position detection circuit 50 can be performed merely by hardware, and the load on the CPU 21 can be further reduced.

Further, in the first embodiment, a case has been described in which when the key 11 is operated from the initial position, the peak value of the voltage at point B input to the rectifier diode 36 varies with respect to the DC voltage Vref of constant magnitude input to the temperature compensation diode 42, causing a difference in the forward voltage of each of the diodes 36 and 42.

In contrast, in the second embodiment, the peak value of the voltage at position A input to the temperature compensation diode 42 also varies in response to the operation of the key 11, similarly to the voltage at position B. Therefore, even when the key 11 is operated from the initial position, a difference in the forward voltage of each of the diodes 36 and 42 is unlikely to occur. Therefore, the temperature dependency of the detection result of the position detection circuit 50, which is based on the temperature dependency of the difference, can be reduced, and the detection accuracy of the position of the key 11 can be improved.

Although the disclosure has been described based on the above embodiments, the disclosure is not limited thereto, and it can be easily understood that various improvements and modifications may be made without departing from the spirit and scope of the disclosure.

In the above embodiment, a case has been described in which the AC voltage output from the magnetic sensor 31 varies in response to the displacement of the displacement member 17 that is linked to the key 11, but the disclosure needs not to be limited thereto. For example, the displacement member 17 may be omitted, and the positions of the detected unit 32 and the coil 33 may be changed as appropriate so that the AC voltage output from the magnetic sensor 31 varies according to the displacement of other displacement members such as a hammer (which works in conjunction with the key 11 and gives a feel when pressing the key) and the key 11. Furthermore, the magnetic sensor 31 is not limited to the one described in the above embodiment, so long as the magnetic sensor 31 can output an AC voltage according to the position of the operator. Instead of the configuration in which the output value increases or decreases as the intrusion amount of the detected unit 32 into the detection area increases or decreases, the magnetic sensor 31 may have a configuration in which the output value increases or decreases as the distance between the detected unit and the detection unit changes. Furthermore, an optical sensor, a capacitance sensor, or the like may be used instead of the magnetic sensor 31 as long as the sensor can output an AC voltage according to the position of the operator.

In the above embodiment, a case has been described in which the electronic musical instrument 10 is a synthesizer, and the position (operation amount) of the key 11 is detected by the magnetic sensor 31 and the position detection circuits 30 and 50, but the disclosure needs not to be limited thereto. For example, the magnetic sensor 31 and the position detection circuits 30 and 50 may be provided in other keyboard instruments of an electronic musical instrument. Further, the magnetic sensor 31 and the position detection circuits 30 and 50 may detect the position of not only the key 11 but also the operator provided on the operation panel 24, a foot keyboard, a pedal, and the like.

In an electronic musical instrument other than a keyboard instrument, such as a percussion instrument, a wind instrument, and a string instrument, the position of the operator may be detected by the magnetic sensor 31 and the position detection circuits 30 and 50. Furthermore, in various devices other than an electronic musical instrument, the position of the operator may be detected by the magnetic sensor 31 and the position detection circuits 30 and 50.

In the above embodiment, a case has been described in which one position detection circuit 30 and one ADC 25 are provided for every eight keys 11, but the disclosure needs not be limited thereto. One position detection circuit 30 may be provided for every 1 to 7 or 9 or more keys 11. Also, one ADC 25 may be provided for every two or more position detection circuits 30. In this case, the ADC 25 may acquire the output from the position detection circuit 30 in a time-division manner.

The fewer the position detection circuits 30 and ADCs 25, the lower the cost and the smaller the electronic musical instrument 10 can be. On the other hand, the more the position detection circuits 30 and ADCs 25 are used, the fewer the number of time divisions can be, thereby improving the responsiveness of the position detection of each of the keys 11. In order to achieve both of the aforementioned, it is preferable to provide one position detection circuit 30 and one ADC 25 for every 4 to 12 keys 11.

In the above embodiment, a case has been described in which the rectifier diode 36 and the temperature compensation diode 42 (temperature compensation circuits 40 and 51) are provided in a one-to-one relationship, but the disclosure needs not be limited thereto. A configuration in which multiple rectifier diodes 36 and one temperature compensation diode 42 (temperature compensation circuits 40 and 51) form one set may also be used. In this case, it is preferable to limit the number of rectifier diodes 36 in one set to, for example, eight or less, so that the temperature of each of the diodes 36 and 42 in one set is close to each other. Compared with a case in which the diodes 36 and 42 are provided in a one-to-one relationship, the number of temperature compensation diodes 42 (temperature compensation circuits 40 and 51) can be reduced by providing the diodes in a multiple-to-one relationship, and the position detection circuits 30 and 50 can be made smaller and less expensive.

In the above embodiment, a case has been described in which the compensation voltage from the temperature compensation circuits 40 and 51 is applied to the anode side of the rectifier diode 36, but a compensation voltage may be applied to the cathode side of the rectifier diode 36. The cathode side refers to the position between the rectifier diode 36 and the smoothing circuit 37, between the smoothing circuit 37 and the LPF 38 (position C), and between the LPF 38 and the ADC 25 (position D).

The method of applying the compensation voltage by the AC coupling 35 is not limited to the case in which the compensation voltage is applied to the anode side or the cathode side of the rectifier diode 36, and the method of applying the compensation voltage may be changed. For example, a compensation voltage may be applied to the anode side or the cathode side of the rectifier diode 36 by a known adder circuit using an operational amplifier.

In addition, the compensation voltage calculated by the temperature compensation circuits 40 and 51 may be input to the CPU 21, and the compensation voltage may be applied to the anode side or the cathode side of the rectifier diode 36 via the CPU 21 (compensation means and compensation step). When the compensation voltage is added via the CPU 21, the compensation voltage can be corrected by the CPU 21 in accordance with the difference in the temperature dependency of each of the diodes 36 and 42, the difference in the current value of each of the diodes 36 and 42, the operation amount of the operator, and the like. Further, the CPU 21 may be configured to add a compensation voltage to the value acquired from the ADC 25 (compensation means and compensation step). In this case as well, it can be said that the compensation voltage is applied to the cathode side of the rectifier diode 36.

In the first embodiment, a case has been described in which the DC voltage Vref output from the reference voltage circuit 41 is set to the peak value of the positive voltage at position A when the key 11 is in the initial position, but the disclosure needs not to be limited thereto. For example, a fixed voltage that is unrelated to the peak value may be set as the DC voltage Vref. The fixed voltage may be equal to or higher than the forward voltage of the temperature compensation diode 42. Moreover, the DC voltage Vref may be varied in accordance with the operation amount of the operator detected by the CPU 21. In this case, similarly to the second embodiment, a difference in the forward voltage of each of the diodes 36 and 42 is unlikely to occur.

In the above embodiment, a case has been described in which the rectifier diode 36 and the temperature compensation diode 42 are integrated into one chip, but the disclosure needs not be limited thereto. For example, the rectifier diode 36 and the temperature compensation diode 42 for compensating for the voltage drop caused by the rectifier diode 36 may be sealed in separate sealing materials. The diodes 36 and 42 provided in a multiple-to-one relationship may be incorporated into one chip, and may be sealed in separate sealing materials.

When each of the diodes 36 and 42 is sealed in a separate sealing material, it is preferable that the diodes 36 and 42 are configured from diodes having the same electrical characteristics, particularly the same forward voltage, at a predetermined temperature (for example, 25° C.). In this way, the temperature dependency of the forward voltage of each of the diodes 36 and 42 can be easily canceled out by each other.

It is more preferable that each of the diodes 36 and 42 be configured from diodes having the same specifications and lot numbers. A lot number is a control number assigned to each of a certain number of products when producing products of the same specifications. If the specifications and lot numbers are the same, it can be said that the temperature dependency of each of the diodes 36 and 42 is approximately the same. As a result, the temperature dependency of the forward voltage of each of the diodes 36 and 42 can be more easily canceled out by each other.

Even if each of the diodes 36 and 42 is not integrated on one chip, it is still preferable to thermally couple each of the diodes 36 and 42 together. Examples of the thermal coupling include disposing each of the diodes 36 and 42 on the same substrate, disposing each of the diodes 36 and 42 adjacent to each other (within 5 mm), and bringing each of the diodes 36 and 42 into contact with each other. In this way, each of the diodes 36 and 42 can be in thermal equilibrium and has approximately the same temperature, and the temperature dependency of the forward voltage of each of the diodes 36 and 42 can be easily canceled out by each other.

In the above embodiment, a case has been described in which the forward voltage (compensation voltage) of the temperature compensation diode 42 is calculated by the subtraction circuit 43 using the operational amplifier 44, but the disclosure needs not be limited thereto. For example, the voltage on the anode side and the voltage on the cathode side of the temperature compensation diode 42 may be input to the CPU 21, and the CPU 21 may calculate the compensation voltage (calculation means and calculation step). Furthermore, the resistance values of the resistors R3 to R6 of the subtraction circuit 43 do not have to be the same, and may be different. In this case, the forward voltage of the temperature compensation diode 42 can be amplified and used as the compensation voltage, and the magnitude of the compensation voltage can be regulated by the subtraction circuit 43.

In the above embodiment, a case has been described in which the compensation voltage is calculated using the temperature compensation diode 36, but the disclosure needs not be limited thereto. Examples include a modified example in which the temperature compensation circuit 40 from the reference voltage circuit 41 to position G in FIG. 3 is omitted, and the wire from the CPU 21 is connected to position G.

In the modified example, during the “magnetic sensor non-drive time” when the CPU 21 does not apply an AC voltage to the coil 33, the DC voltage Vref is input from the CPU 21 through the joining line 45 to the resistor R7. At this time, since no AC voltage is output from the magnetic sensor 31, when the amplification factor of the LPF 38 is 1, the output value of the ADC 25 becomes a voltage (Vref−Vf) obtained by dropping the forward voltage Vf of the rectifier diode 36 from the DC voltage Vref. Therefore, the forward voltage Vf (compensation voltage) of the rectifier diode 36, which is the difference between the DC voltage Vref and the output value of the ADC 25, is calculated by the CPU 21 (calculation means and calculation step), and stored in the CPU 21 for each of the position detection circuits 30 (rectifier diodes 36) and each of the magnetic sensors 31. If the amplification factor of the LPF 38 is other than 1, the CPU 21 may convert the output value of the ADC 25 to a value before amplification, and calculate the compensation voltage based on the converted value and the DC voltage Vref.

Next, during the “magnetic sensor drive time” when the CPU 21 applies an AC voltage to the coil 33, the compensation voltage calculated as described above is applied to the resistor R7 from the CPU 21 via the joining line 45 (compensation means and compensation step) to compensate for the voltage drop of the forward voltage Vf of the rectifier diode 36.

In such a modified example, the forward voltage Vf (compensation voltage) of the rectifier diode 36 itself can be obtained in a time-division manner to perform temperature compensation. That is, the temperature compensation circuit 40 is not required, and the detection accuracy of the position of the key 11 based on the detection result of the position detection circuit 30 can be improved. However, when the temperature compensation circuit 40 is used, the load on the CPU 21 can be reduced.

What is claimed is:

1. An electronic musical instrument, comprising:
an operator, of which position is changed by being operated by a performer;
a magnetic sensor, outputting an alternating current (AC) voltage in response to a change in the position of the operator;
a rectifier diode, receiving the AC voltage from the magnetic sensor at an anode and outputting a voltage rectified from a cathode;
a calculation circuit, calculating a compensation voltage from a forward voltage generated in a diode to which a predetermined voltage is applied in a forward direction; and
a compensation circuit, applying the compensation voltage calculated by the calculation circuit to an anode side or a cathode side of the rectifier diode in a state where the AC voltage from the magnetic sensor is being input, and
the position of the operator being detected according to the voltage from the rectifier diode to which the compensation voltage is applied by the compensation circuit.

2. The electronic musical instrument according to claim 1, wherein the diode used in the calculation circuit is a temperature compensation diode provided separately from the rectifier diode.

3. The electronic musical instrument according to claim 2, wherein the calculation circuit is a subtraction circuit using an operational amplifier that receives a voltage on an anode side of the temperature compensation diode and a voltage on a cathode side of the temperature compensation diode, and outputs a difference between the voltages as the compensation voltage from an output terminal.

4. The electronic musical instrument according to claim 3, wherein the compensation circuit is an AC coupling formed by a capacitor connecting the magnetic sensor and the rectifier diode and a resistor connecting a branch between the capacitor and the rectifier diode to the output terminal of the operational amplifier.

5. The electronic musical instrument according to claim 4, further comprising:
a branch wire, branched from the magnetic sensor side of the capacitor and connected to an anode of the temperature compensation diode so that a voltage on the magnetic sensor side of the capacitor becomes the predetermined voltage; and
an offset power supply, adding an offset voltage of direct current (DC) to the AC voltage output from the magnetic sensor and making the entire predetermined voltage equal to or greater than a forward voltage of the temperature compensation diode.

6. The electronic musical instrument according to claim 2, wherein the rectifier diode and the temperature compensation diode are diodes having the same specifications and lot numbers.

7. The electronic musical instrument according to claim 2, wherein the rectifier diode and the temperature compensation diode are thermally coupled.

8. The electronic musical instrument according to claim 7, wherein the rectifier diode and the temperature compensation diode are sealed in the same sealing material.

9. The electronic musical instrument according to claim 3, wherein the rectifier diode and the temperature compensation diode are thermally coupled.

10. The electronic musical instrument according to claim 9, wherein the rectifier diode and the temperature compensation diode are sealed in the same sealing material.

11. The electronic musical instrument according to claim 4, wherein the rectifier diode and the temperature compensation diode are thermally coupled.

12. The electronic musical instrument according to claim 11, wherein the rectifier diode and the temperature compensation diode are sealed in the same sealing material.

13. The electronic musical instrument according to claim 5, wherein the rectifier diode and the temperature compensation diode are thermally coupled.

14. The electronic musical instrument according to claim 13, wherein the rectifier diode and the temperature compensation diode are sealed in the same sealing material.

15. The electronic musical instrument according to claim 6, wherein the rectifier diode and the temperature compensation diode are thermally coupled.

16. The electronic musical instrument according to claim 15, wherein the rectifier diode and the temperature compensation diode are sealed in the same sealing material.

17. The electronic musical instrument according to claim 1, wherein the diode used in the calculation circuit is the rectifier diode in a state where no AC voltage from the magnetic sensor is being input.

18. A method for temperature compensation of a position detection circuit for an electronic musical instrument which comprises an operator of which position is changed by being operated by a performer, a magnetic sensor which outputs an AC voltage in response to a change in the position of the operator, and a rectifier diode which receives the AC voltage from the magnetic sensor at an anode and outputs a voltage rectified from a cathode, the method for temperature compensation of the position detection circuit, comprising:
calculating a compensation voltage from a forward voltage generated in a diode to which a predetermined voltage is applied in a forward direction; and
performing compensation by applying the compensation voltage calculated to an anode side or a cathode side of the rectifier diode in a state where the AC voltage from the magnetic sensor is being input, and the position of the operator being detected according to the voltage from the rectifier diode to which the compensation voltage is applied.

19. The method for temperature compensation according to claim 18, wherein the diode used for calculating the compensation voltage is a temperature compensation diode provided separately from the rectifier diode.

20. The method for temperature compensation according to claim 19, wherein in calculating the compensation voltage, a difference between a voltage on an anode side of the temperature compensation diode and a voltage on a cathode side of the temperature compensation diode is calculated as the compensation voltage.
